(19) United States
(12) Patent Application Publication
(10) Pub. No.: US 2025/0233331 A1
(43) Pub. Date: Jul. 17, 2025

(54) ELECTRICAL CONNECTOR ASSEMBLY, BOARD END CONNECTOR AND WIRE END CONNECTOR

(71) Applicant: BELLWETHER ELECTRONIC CORP., Taoyuan City (TW)

(72) Inventor: Hsing-Yu Lee, Taoyuan City (TW)

(21) Appl. No.: 18/942,925

(22) Filed: Nov. 11, 2024

Related U.S. Application Data
(60) Provisional application No. 63/622,021, filed on Jan. 17, 2024.

(51) Int. Cl. H01R 12/75; H01R 12/70; H01R 13/506

(52) U.S. Cl. CPC H01R 12/75; H01R 12/7005; H01R 13/506

(57) ABSTRACT

An electrical connector assembly includes a board end connector and a wire end connector. The board end connector includes an insulative body and two conductive columns. The wire end connector includes an insulative housing and two conductive members. The insulative body includes a first latching member. The insulative housing includes two accommodating cavities therein. The insulative housing includes a plurality of lateral openings that are interconnected to the two accommodating cavities. A bottom of the insulative housing has a plurality of through holes that are interconnected to the two accommodating cavities. The insulative housing has a first sidewall and a second sidewall. There is a corner area between the first sidewall and the second sidewall. The corner area has a second latching member. The two conductive members are at least partially disposed in the two accommodating cavities, respectively.

### CROSS-REFERENCE TO RELATED PATENT APPLICATION

This application claims the benefit of priority to the U.S. Provisional Patent Application Ser. No. 63/622,021, filed on Jan. 17, 2024, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an electrical connector assembly, and more particularly to an electrical connector assembly having a board end connector and a wire end connector that are provided with latching members.

### BACKGROUND OF THE DISCLOSURE

In the related art, in order to prevent the board end connector and the wire end connector that are mated with each other from loosening, the stability of the overall structure is enhanced through structural design of the latching members. However, the existing latching members can be positioned inappropriately due to volume or appearance, making it difficult for users to exert a force for operation thereof.

Therefore, how to overcome the above-mentioned problem through an improvement in structural design has become an important issue to be addressed in the related art.

### SUMMARY OF THE DISCLOSURE

In response to the above-referenced technical inadequacy, the present disclosure provides an electrical connector assembly having a board end connector and a wire end connector, to address an issue of the existing latching members being positioned inappropriately and being difficult to operate.

In order to solve the above-mentioned problems, one of the technical aspects adopted by the present disclosure is to provide an electrical connector assembly, which includes a board end connector and a wire end connector. The board end connector includes an insulative body and two conductive columns. The insulative body is disposed on a circuit board and includes a first latching member. The two conductive columns are disposed on the insulative body and electrically connected to the circuit board. The insulative housing includes two accommodating cavities therein. A side of the insulative housing includes two lateral openings that are interconnected with the two accommodating cavities. A bottom of the insulative housing includes a plurality of through holes that are interconnected with the two accommodating cavities. The insulative housing includes a first sidewall and a second sidewall that is perpendicular to the first sidewall. A corner area is adjacent to the first sidewall, and the corner area has a second latching member. The two conductive members are at least partially disposed in the two accommodating cavities, respectively. When the wire end connector is mated with the board end connector, the first latching member is latched with the second latching member, and the two conductive columns respectively pass through two of the through holes to be electrically connected to the two conductive members.

In order to solve the above-mentioned problems, another one of the technical aspects adopted by the present disclosure is to provide a board end connector assembly, which includes an insulative body and two conductive columns. The insulative body is disposed on a circuit board and includes a latching member. The two conductive columns are disposed on the insulative body along a diagonal line that is defined on the insulative body, and the two conductive columns are electrically connected to the circuit board. The insulative body has four sides and defines a first center line and a second center line, the first center line is located at a middle position between two opposite ones of the four sides, and the second center line is located at a middle position between the other two opposite ones of the four sides. The first center line and the second center line are used to divide the insulative body into four areas, and the latching member is located within one of the four areas.

In order to solve the above-mentioned problems, yet another one of the technical aspects adopted by the present disclosure is to provide a wire end connector, which includes insulative housing and two conductive members. The insulative housing includes two accommodating cavities therein. A side of the insulative housing includes two lateral openings that are interconnected with the two accommodating cavities, respectively. A bottom of the insulative housing includes two through holes that are interconnected with the two accommodating cavities, respectively. The insulative housing includes a first sidewall and a second sidewall that is perpendicular to the first sidewall. The first sidewall and the second sidewall have a corner area therebetween, and the corner area has a latching member. Two conductive members are disposed in the two accommodating cavities, respectively. The two conductive members are electrically connected with a conductive cable.

Therefore, in an electrical connector assembly, a board end connector and a wire end connector provided by the present disclosure, by arranging the second latching member in the corner area of the insulative housing and placing the first latching member in one of the four areas of the insulative body that are divided by the first line and the second center line, a user can comfortably grasp the insulative housing and easily plug the wire end connector into the board end connector, or unplug the wire end connector from the board end connector.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an electrical connector assembly according to an embodiment of the present disclosure;

FIG. 2 is a schematic exploded view of the electrical connector assembly according to the embodiment of the present disclosure;

FIG. 3 is a schematic view of a board end connector according to the embodiment of the present disclosure;

FIG. 4 is a schematic top view of the board end connector according to the embodiment of the present disclosure;

FIG. 5 is a schematic view of a conductive column according to the embodiment of the present disclosure;

FIG. 6 is a schematic view of a wire end connector according to the embodiment of the present disclosure;

FIG. 7 is a schematic top view of the wire end connector according to the embodiment of the present disclosure;

FIG. 8 is a schematic view of the board end connector being plugged with the wire end connector according to the embodiment of the present disclosure;

FIG. 9 is a schematic view of the electrical connector assembly being connected to a busbar clip connector according to the embodiment of the present disclosure; and

FIG. 10 is partial schematic view of the electrical connector assembly being connected to the busbar clip connector according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Embodiment

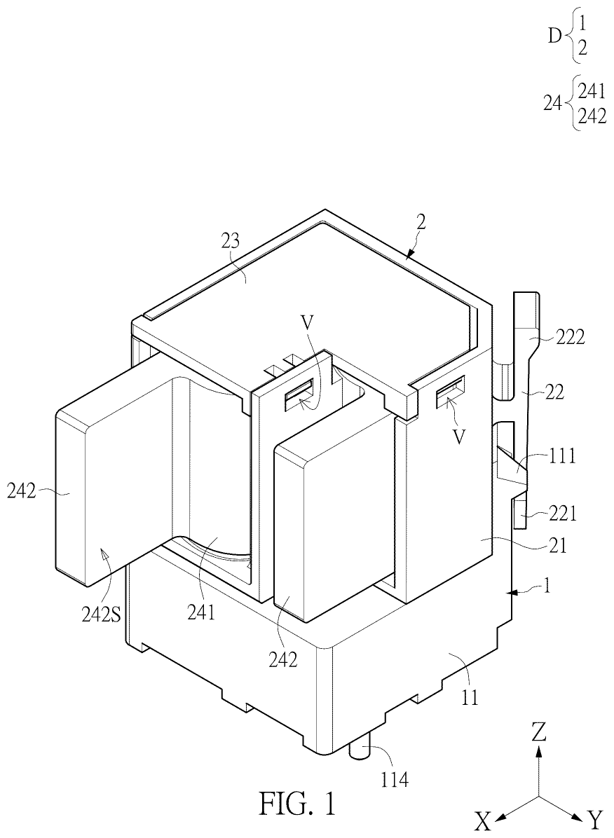

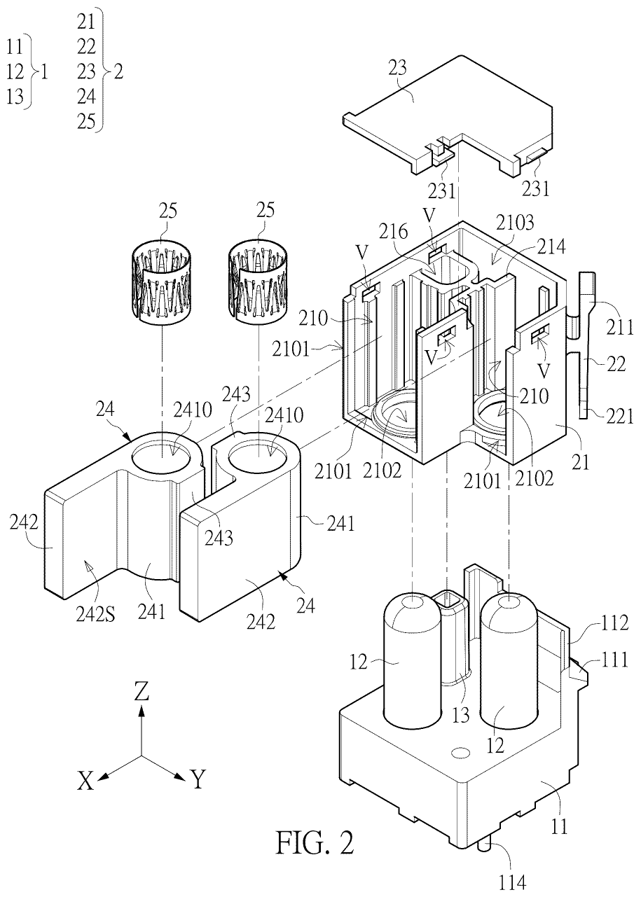

Reference is made to FIG. 1 and FIG. 2. FIG. 1 is a schematic view of an electrical connector assembly according to an embodiment of the present disclosure. FIG. 2 is a schematic exploded view of the electrical connector assembly according to the embodiment of the present disclosure. An embodiment of the present disclosure provides an electrical connector assembly D, which includes a board connector 1 and a wire end connector 2. The wire end connector 2 is detachably mated with the board end connector 1.

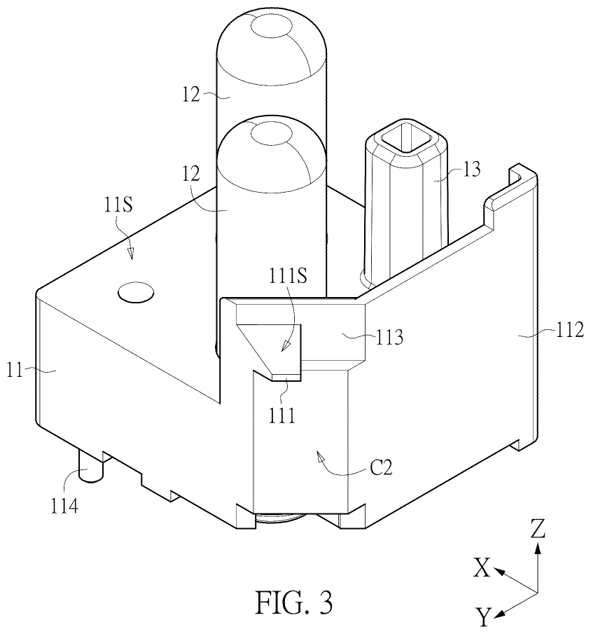

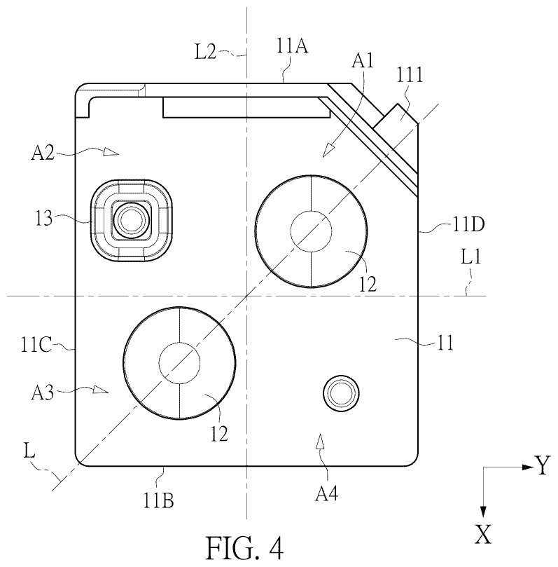

Reference is made to FIG. 2 to FIG. 4. FIG. 3 is a schematic view of a board end connector according to the embodiment of the present disclosure. FIG. 4 is a schematic top view of the board end connector according to the embodiment of the present disclosure. The board end connector 1 includes an insulative body 11 and two conductive columns 12. The insulative body 11 includes a first latching member 11. The insulative body 11 includes a positioning pin 114 at a bottom thereof. The insulative body 11 is positioned to a circuit board (not shown in the figures) through positioning pins 114. The two conductive columns 12 are disposed on the insulative body 11 and are electrically connected to the circuit board. The two conductive columns 12 are arranged diagonally. The two conductive columns 12 and the first latching member 111 are arranged along a diagonal line L of the insulative body 11. In other words, the diagonal line L is an extension line connecting the two conductive columns 12, and the first latching member 111 is located on the extension line. That is, the first latching member 111 is located at a vertex (i.e., a corner) of the insulative body 11.

As shown in FIG. 3, the insulative body 11 forms a square shape that has four sides 11A, 11B, 11C, 11D. One of the sides (i.e., the side 11A) extends to form a sidewall 112. The sidewall 112 is arranged along an edge of the insulative body 11. The sidewall 112 includes a bending portion 113. The first latching member 111 is fixed on the bending portion 113. An upper end of the first latching member 111 has an inclined surface 111S that is inclined downward (i.e., toward a negative Z-axis direction). The insulative body 11 includes a chamfered surface C2 that is formed between two adjacent sides of the four sides. Therefore, when the sidewall 112 is disposed along the edge of the insulative body 11, the bending portion 113 is formed along with the design of the chamfered surface C2.

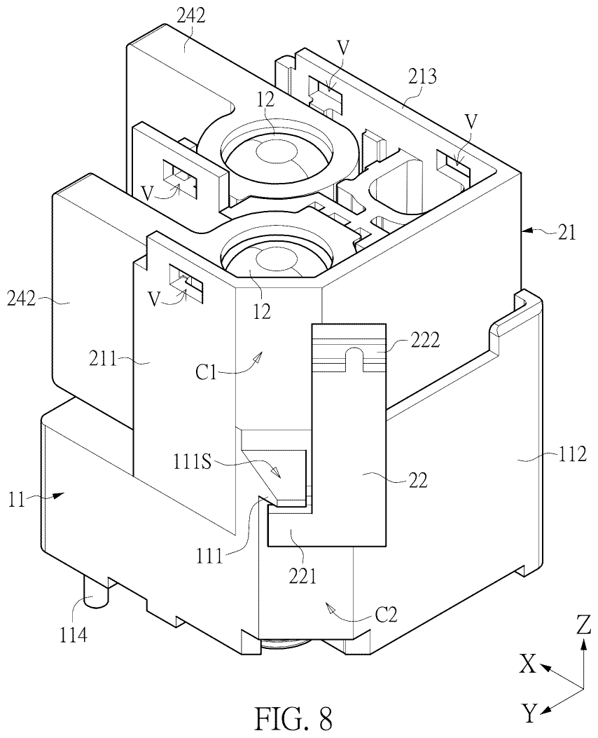

The extension range of the sidewall 112 is not limited in the present disclosure. As shown in FIG. 3 and FIG. 4, the sidewall 112 extends along an edge of the insulative body 11 in a Y-axis direction and an edge of the chamfered surface C2, but the present disclosure is not limited thereto. In other embodiments, the sidewall 112 can further extend along the edge of the insulative body 11 in an X-axis direction. Moreover, reference is made to FIG. 8 in advance. At least a portion of the sidewall 112 is located on a side (i.e., the side 11A in FIG. 4) of the wire end connector 2, which is opposite to another side (i.e., the side 11B in FIG. 4) of the wire end connector 2 that is connected to a conductive cable B11, such that the stability of the overall structure can be further enhanced.

As shown in FIG. 4, the insulative body 11 can define a first center line L1 and a second center line L2. The first center line L1 is located at a middle position between two opposite sides (i.e., the side 11A and the side 11B) of the four sides 11A, 11B, 11C, 11D, and the second center line L2 is located at a middle position between the other two opposite sides (i.e., the side 11C and the side 11D) of the four sides 11A, 11B, 11C, 11D. The first center line L1 and the second center line L2 are used to divide the insulative body 11 into four areas A1, A2, A3, A4, and the latching member 111 is located at one of the four areas (i.e., the area A1).

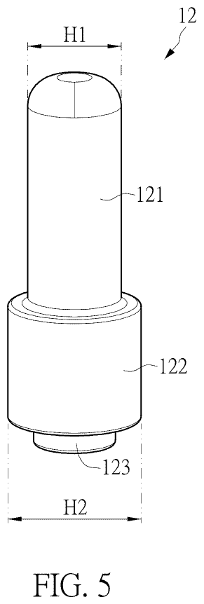

Reference is made to FIG. 3 and FIG. 5. FIG. 5 is a schematic view of a conductive column according to the embodiment of the present disclosure. Each of the conductive columns 12 includes a body portion 121, a fixing portion 122, and a leg portion 123. The fixing portion 122 is connected between the body portion 121 and the leg portion 123. A diameter H2 of the fixing portion 122 is larger than a diameter H1 of either the body portion 121 or the leg portion 123. The conductive column 12 is fixed in the insulative body 11 through the fixing portion 122. The leg portion 123 is exposed from the bottom of the insulative body 11 and is electrically connected to the circuit board, and the body portion 121 is exposed from an upper surface 11S of the insulative body 11. Furthermore, the insulative body 11 further includes a limiting column 13 that is disposed on the upper surface 11S. The limiting column 13 is adjacent to another vertex (i.e., another corner) of the insulative body 11 that is adjacent to the corner where the first latching member 111 is located.

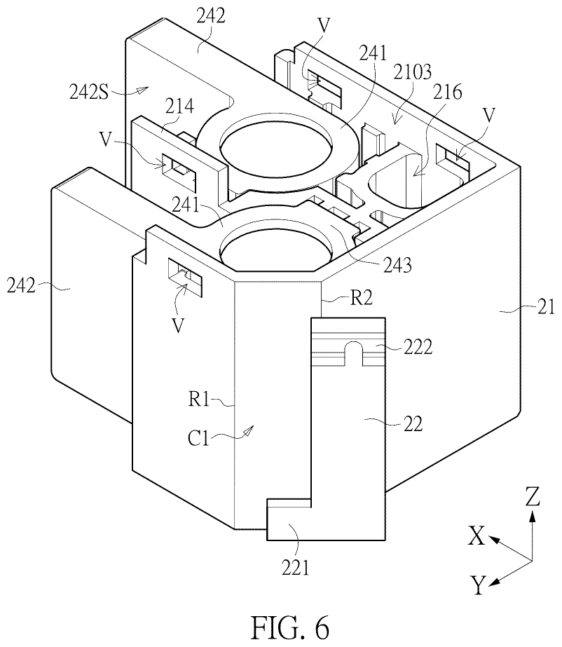

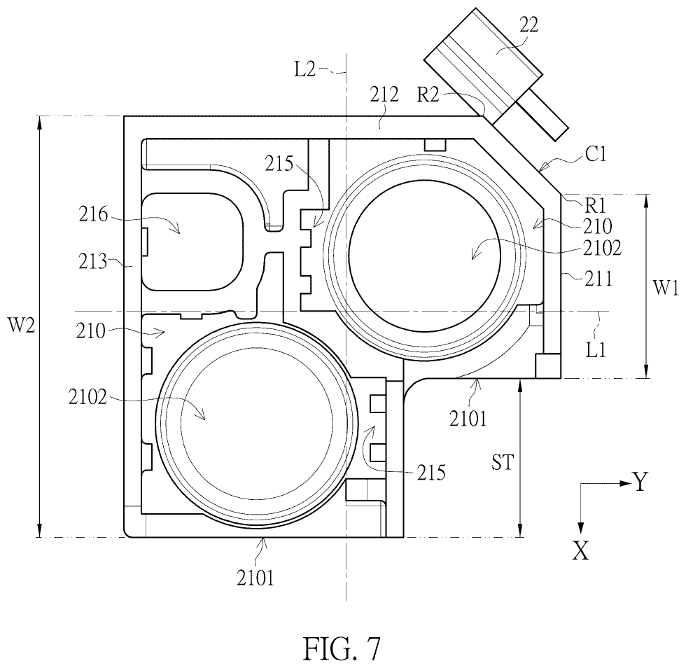

Reference is made to FIGS. 2, 6, and 7. FIG. 6 is a schematic view of a wire end connector according to the embodiment of the present disclosure. FIG. 7 is a schematic top view of the wire end connector according to the embodiment of the present disclosure. The wire end connector 2 includes an insulative housing 21, a second latching member 22, an upper cover 12, and two conductive members 24. The insulative housing 21 includes a partition wall 214. The partition wall 214 is used to divide an interior of the insulative housing 21 into two accommodating cavities 210. A side of the insulative housing 21 includes two lateral openings 2101, a bottom of the insulative housing 21 includes a plurality of through holes 2102, and a top of the insulative housing 21 includes an upper opening 2103. The two lateral openings 2101, two of the plurality of through holes 2102, and the upper opening 2103 are interconnected with the two accommodating cavities210, respectively.

The upper cover 23 is disposed on the top of the insulative housing 21. The upper cover 23 includes a plurality of buckle portions 231. The side of the insulative housing 21 includes a plurality of retaining holes V. Top upper cover 23 covers the upper opening 2103 of the insulative housing 21 by the plurality of buckle portions 231 being engaged with the plurality of retaining holes V.

The insulative housing 21 has a first sidewall 211, a second sidewall 212, and a third sidewall 213. The first sidewall 211 is perpendicular to the second sidewall 212. The third sidewall 213 is vertically connected to the second sidewall 212. The third sidewall 213 is parallel to the first sidewall 211. The second sidewall 212 is located between the first sidewall 211 and the third sidewall 213. The second latching member 22 is closer to the first sidewall 211 than the third sidewall 213. The first sidewall 211 and the second sidewall 212 have a corner area C therebetween. The second latching member 22 is disposed in the corner area C. Specifically, the corner area C includes a chamfered surface C1. An included angle between the chamfer surface C1 and the first sidewall 211, and an included angle between the chamfer surface C1 and the second sidewall 212 range between 90 degrees to 180 degrees. The second latching member 22 is disposed on the chamfer surface C1. The two lateral opening 2101 are adjacent to the first sidewall 211 and the third sidewall 213, respectively. In the X-axis direction, a width W1 of the first sidewall 211 is less than a width W2 of the third sidewall 213. Therefore, there is a step difference ST between the two lateral openings 2101. That is, the two lateral openings 2101 are not in a same straight line along the Y-axis direction, and one of the two lateral openings 2101 is closer to the second sidewall than another one of the two lateral openings 2101.

As shown in FIG. 7, the insulative housing 21, like the insulative body 11, can define the first center line L1 and the second center line L2 as well. The second center line L2 is parallel to the first sidewall 211 and the third sidewall 213, and the second center line L2 is located at a middle position between the first sidewall 211 and the third sidewall 213. The first center line L1 is perpendicular to the first sidewall 211 and intersects at a middle position of the third sidewall 213. The chamfered surface C1 and the first sidewall 211 intersect at the first boundary line R1, and the chamfered surface C1 and the second sidewall 212 intersect at the second boundary line R2. The position of the first boundary line R1 does not exceed the first center line L1 along the X-axis direction, and the position of the second boundary line R2 does not exceed the second center line L2 along the Y-axis direction. That is, the range of the angular area C can be limited between the first center line L1 and the second center line L2, and the angular area C is located within one of the four areas divided by the first boundary line R1 and the second boundary line R2.

The latching member of the existing connector is arranged at a center area of vertical or horizontal sides of the housing. That is, the housing is not specially designed with a chamfered surface for placing the latching member. An user generally grasps the connector by the thumb and the middle finger, and further presses the latching member with the index finger. However, when the user opens his fingers, the included angles between the thumb, the middle finger, and the index finger are different, which is difficult for the user to exert a force with the index finger when picking up the housing. In contrast, as shown in FIGS. 1 and 7, in the present disclosure, the second latching member 22 is disposed on the chamfered surface C1 of the insulative housing 21, and the first latching member 111 is disposed on the chamfered surface C2 of the insulative body 11. When the user grasps the wire end connector 2 with his hand (for example, his right hand) and plugs it into the board end connector 1, the user touches the third sidewall 213 of the insulative housing 21 with his thumb and touches the first sidewall 211 with his middle finger. In the meantime, the index finger can be appropriately placed on the second latching member 22 of the chamfered surface C1. In other words, the position of the second latching member 22 is designed to match the gestures of the user, allowing the user to comfortably exert the force to operate the second latching member 22. More specifically, in the present disclosure, by arranging the second latching member 22 on the chamfered surface C1 between the first sidewall 211 and the second sidewall 212, the user can operate the second latching member 22 more smoothly.

However, the aforementioned description for the chamfered surfaces C1 and C2 of the embodiment is merely an example, and is not meant to limit the scope of the present disclosure. As shown in FIGS. 6 and 7, the insulative housing 21 can be designed without the chamfered surface C1. The second latching member 22 is arranged on the second sidewall 212 and closer to a right vertex than the second center line L2. Similarly, as shown in FIG. 3, the insulative body 11 can be designed without the chamfered surface C2. The second latching member 22 is arranged on the side 11A, and closer to a right vertex than the second center line L2. Therefore, in the present disclosure, the structure of the insulative housing 21 in the corner area C can be designed as a chamfered surface or a side surface. Comparing the chamfered surface with the side surface, the design of the chamfered surface C1 in FIGS. 6 and 7 can further reduce the size of the insulative housing 21 and save more manufacturing material costs. In addition, the position of the chamfer surface C1 is not limited in the present disclosure. In other embodiments, the chamfered surface C1 can be arranged between the second sidewall 212 and the third sidewall 213 to be suitable for left-handed users.

Reference is made to FIG. 2 and FIG. 7. The insulative housing 21 further includes a guiding channel 216 therein. The guiding channel 216 penetrates the bottom of the insulative housing 21. The second latching member 22 includes a hook portion 221 and a pressing portion 222. Each of the conductive members 24 includes a hollow cylindrical structure 241 and a plate-shaped structure 242. An axial direction (i.e., the Z-axis direction) of the hollow cylindrical structure 241 is perpendicular to an extension direction (i.e., the X-axis direction) of the plate-shaped structure 242.

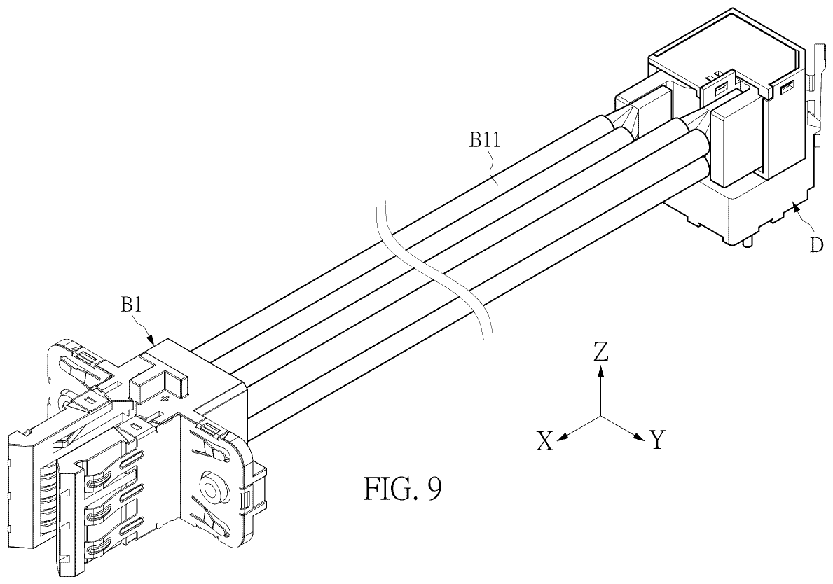

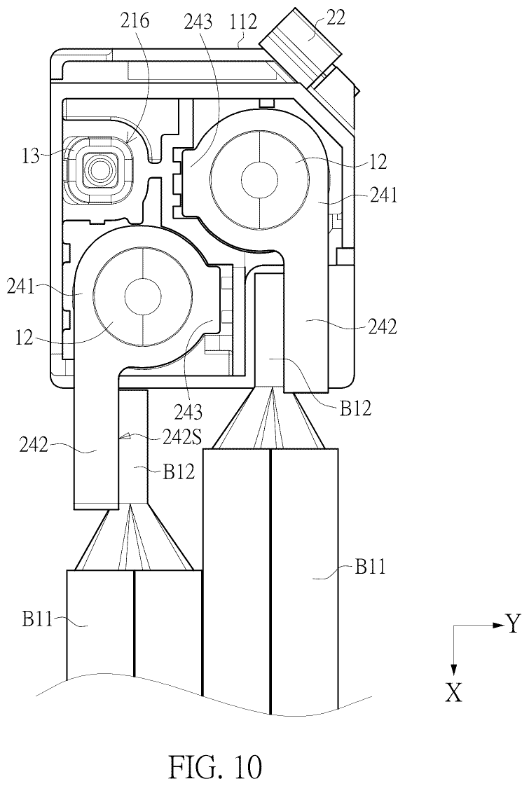

Reference is made to FIG. 8 to FIG. 10. FIG. 8 is a schematic view of the board end connector being plugged with the wire end connector according to the embodiment of the present disclosure. FIG. 9 is a schematic view of the electrical connector assembly being connected to a busbar clip connector according to the embodiment of the present disclosure. FIG. 10 is partial schematic view of the electrical connector assembly being connected to the busbar clip connector according to the embodiment of the present disclosure. During the assembly of the wire end connector 2, the hollow cylindrical structure 241 is located in corresponding one of the accommodating cavities 210, and the plate-shaped structure 242 extends out of the insulative housing 21 along the extension direction (I.e., the X-axis direction) and toward corresponding one of the lateral openings 2101. From the top perspective of FIG. 10, the two conductive members 24 are arranged diagonally, so the two plate-shaped structures 242 are not flush in the extension direction. The two plate-shaped structures 242 are adjacent and parallel to the first sidewall 211 and the third sidewall 213, respectively.

As shown in FIG. 2 and FIG, 8, During the mating of the wire end connector 2 and the board end connector 1, the insulative housing 21 moves to be engaged with the insulative body 11 along a docking direction (i.e., the Z-axis direction). The position of the chamfered surface C1 of the insulative housing 21 overlaps the position of the chamfered surface C2 of the insulative body 11, so that the second latching member 22 is latched with the first latching member 11. More specifically, the hook portion 221 of the second latching member 22 abuts against the inclined surface 111S, moves along the inclined surface 111S to below the first latching member 111, and abuts against the bottom of the first latching member 111, so that the insulative housing 21 is fixed to the insulative body 11. When the insulative housing 21 is engaged with the insulative body 11, the two conductive columns 12 respectively pass through two of the through holes 2102 to electrically connect the two conductive members 24, and the limiting column 13 are inserted into the guiding channel 216 to perform positioning between the insulative housing 21 and the insulative body 11. Moreover, the limiting column 13 is a hollow rectangular cylinder. A nut (not shown in the figures) can be installed in the limiting column 13, and a screw column (not shown) can be used for locking, so as to fix the insulative body 11 onto the circuit board.

As shown in FIG. 9 and FIG. 10, the two conductive members 24 are electrically connected to an external connector, which includes but not limited to, a busbar clip connector B1. Each of the two conductive cables B11 of the busbar clip connector B1 includes a connecting portion B12. The connecting portion B12 is connected to a connection surface 242S of the corresponding plate-shaped structure 242 through ultrasonic welding. The connection surface 242S is located on an inner side of the plate-shaped structure 242, so that the two connecting portions B12 are located between the two plate-shaped structures 242.

As shown in FIG. 7 and FIG. 10, each of the conductive members 24 includes a protruding rib 243 that is disposed on an outer wall of the hollow cylindrical structure 241. The insulative housing 21 includes two recesses 215 on both sides of the partition wall 214, and the two recesses 215 correspond to the two accommodation cavities 210, respectively. When the two hollow cylindrical structures 241 are respectively disposed in the insulative housing 21, the two protruding ribs 243 are respectively engaged into the two recesses 215. Since the hollow cylindrical structure 241 of the two conductive members 24 are arranged diagonally, projections of the two conductive members 24 projected onto a same plane (e.g., any plane parallel to a Y-Z plane, such as the outer surface of the second sidewall 212) that are perpendicular to their extension direction (i.e., the X-axis direction) overlap with each other. In other words, some areas of both conductive members 24 fall on the second center line L2. Thereby, the size of the wire end connector 2 can be further reduced. Moreover, projections of the two conductive columns 12 of the board end connector 1 projected onto the Y-Z plane are staggered and do not overlap with each other, as shown in FIG. 4.

Reference is further made to FIG. 2. The wire end connector 2 can further include two auxiliary conductive members 25, which are respectively disposed in two hollow cylindrical structures 241. The auxiliary conductive member 25 forms an annular structure. When each of the conductive columns 12 is plugged into the corresponding hollow cylindrical structure 241, the two auxiliary conductive members 25 are sleeved on the conductive columns 12, respectively, so that the conductive columns 12 are electrically connected to the conductive members 24 through the auxiliary conductive members 25. For example, each of the auxiliary conductive members 25 can be a crown spring terminal, which includes a plurality of conductive elastic arms. Each of conductive elastic arms is a cantilever structure. That is, one end of the conductive elastic arm is a fixed end, and another end of the conductive elastic arm is a free end. When the conductive columns 12 are plugged into the hollow cylindrical structures 241 that are equipped with the auxiliary conductive members 25, the conductive columns 12 are in physical contact with each of the conductive elastic arms, and each of the conductive elastic arms is compressed and elastically deformed.

Reference is made to FIG. 9 and FIG. 10. When the wire end connector 2 is to be separated from the board end connector 1, the user grasps the wire end connector 2 with his hand (e.g., the right hand), presses the pressing portion 222 with the index finger, and exerts a force on the pressing portion 222 toward the insulative housing 21, such that the hook portion 221 no longer abuts the bottom of the first latching member 111, causing the second latching member 22 to separate from the first latching member 111.

### Beneficial Effects of the Embodiment

In the electrical connector assembly D, the board end connector 1, and the wire end connector 2 provided by the present disclosure, by a virtue of “the insulative housing 21 including a first sidewall 211 and a second sidewall 212 that is perpendicular to the first sidewall 211, the first sidewall 211 and the second sidewall 212 having a corner area C therebetween, and the corner area C having a second latching member 212,” the second latching member 212 is disposed on the corner area C, such that the user can comfortably grasp the insulative housing 21 and easily plug the wire end connector 2 into the board end connector 1, or unplug the wire end connector 2 from the board end connector 1.

Moreover, the latching member of the existing connector is arranged at the center area of vertical or horizontal sides of the housing. That is, the housing is not specially designed with a chamfered surface for placing the latching member. An user generally grasps the connector by the thumb and the middle finger, and further presses the latching member with the index finger. However, when the user opens his fingers, the included angles between the thumb, the middle finger, and the index finger are different, which is difficult for the user to exert a force with the index finger when picking up the housing. In contrast, as shown in FIGS. 1 and 7, in the present disclosure, the second latching member 22 is disposed on the chamfered surface C1 of the insulative housing 21, and the first latching member 111 is disposed on the chamfered surface C2 of the insulative body 11. When the user grasps the wire end connector 2 with his hand (for example, his right hand) and plugs it into the board end connector 1, the user touches the third sidewall 213 of the insulative housing 21 with his thumb and touches the first sidewall 211 with his middle finger. In the meantime, the index finger can be appropriately placed on the second latching member 22 of the chamfered surface C1. In other words, the position of the second latching member 22 is designed to match the gestures of the user, allowing the user to comfortably exert the force to operate the second latching member 22. More specifically, in the present disclosure, by arranging the second latching member 22 on the chamfered surface C1 between the first sidewall 211 and the second sidewall 212, the user can operate the second latching member 22 more smoothly.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electrical connector assembly, comprising:
a board end connector including:
an insulative body disposed on a circuit board and including a first latching member; and
two conductive columns disposed on the insulative body and electrically connected to the circuit board; and
a wire end connector detachably mating with the board end connector and including:
an insulative housing including two accommodating cavities therein, wherein a side of the insulative housing includes two lateral openings that are interconnected with the two accommodating cavities, respectively, a bottom of the insulative housing includes a plurality of through holes that are interconnected with the two accommodating cavities, the insulative housing includes a first sidewall and a second sidewall that is perpendicular to the first sidewall, a corner area is adjacent to the first sidewall, and the corner area has a second latching member; and
two conductive members, wherein the two conductive members are at least partially disposed in the two accommodating cavities, respectively;
wherein, when the wire end connector is mated with the board end connector, the first latching member is latched with the second latching member, and the two conductive columns respectively pass through two of the through holes to be electrically connected to the two conductive members.

2. The electrical connector assembly according to claim 1, wherein the insulative body further includes a sidewall, the sidewall is arranged along an edge of the insulative body, the sidewall includes a bending portion, and the first latching member is fixed on the bending portion.

3. The electrical connector assembly according to claim 2, wherein the two conductive columns are arranged diagonally, and the two conductive columns and the first latching member are arranged along a diagonal line of the insulative body.

4. The electrical connector assembly according to claim 1, wherein the corner area includes a chamfered surface between the first sidewall and the second sidewall, and the second latching member is disposed on the chamfered surface.

5. The electrical connector assembly according to claim 4, wherein the insulative housing further includes a third sidewall that is parallel to the first sidewall, the second sidewall is located between the first sidewall and the third sidewall, a first center line and a second center line are defined on the insulative housing, the second center line is parallel to the third sidewall and is located at a middle position between the first sidewall and the third sidewall, and the first center line is perpendicular to the third sidewall and intersects at a middle position of the third sidewall; wherein the chamfered surface and the first sidewall intersect at a first boundary line, the chamfered surface and the second sidewall intersect at a second boundary line, a position of the first boundary line does not exceed the first center line, and a position of the second boundary line does not exceed the second center line.

6. The electrical connector assembly according to claim 1, wherein the insulative housing further includes a third sidewall that is parallel to the first sidewall, the second sidewall is located between the first sidewall and the third sidewall, and the second latching member is closer to the first sidewall than the third sidewall.

7. The electrical connector assembly according to claim 1, wherein each of the conductive members includes a hollow cylindrical structure and a plate-shaped structure, the hollow cylindrical structure is located in a corresponding one of the accommodating cavities, and the plate-shaped structure is connected to the hollow cylindrical structure and extends toward a corresponding one of the lateral openings.

8. The electrical connector assembly according to claim 7, wherein each of the conductive members further includes a protruding rib, the protruding rib is disposed on an outer sidewall of the hollow cylindrical structure, and two projections of the two protruding ribs projected onto the second sidewall overlap with each other.

9. The electrical connector assembly according to claim 8, wherein the insulative housing further includes a partition wall therein, the partition wall is used to separate the two accommodating cavities, both sides of the partition wall have two recesses, respectively, and the two recesses correspond to the two accommodating cavities, respectively; wherein, when each of the conductive members is disposed in the corresponding one of the accommodating cavities, each of the protruding ribs is engaged into a corresponding one of the recesses.

10. The electrical connector assembly according to claim 1, wherein the insulative housing further includes a guiding channel therein, the guiding channel penetrates the bottom of the insulative housing, the insulative body further includes a limiting column; wherein, when the insulative housing is engaged with the insulative body, the limiting column passes through one of the through holes to be inserted into the guiding channel.

11. A board end connector, comprising:
an insulative body disposed on a circuit board and including a latching member; and
two conductive columns disposed on the insulative body along a diagonal line that is defined on the insulative body, wherein the two conductive columns are electrically connected to the circuit board; and
wherein the insulative body has four sides and defines a first center line and a second center line, the first center line is located at a middle position between two opposite ones of the four sides, the second center line is located at a middle position between another two opposite ones of the four sides, the first center line and the second center line are used to divide the insulative body into four areas, and the latching member is located within one of the four areas.

12. The board end connector according to claim 11, wherein the insulative body forms a chamfered surface between two of the four sides that are adjacent to each other, and the latching member is connected to the chamfered surface.

13. The board end connector according to claim 11, wherein the latching member is located on an extension line connecting the two conductive columns.

14. A wire end connector, comprising:
an insulative housing including two accommodating cavities therein, wherein a side of the insulative housing includes two lateral openings that are interconnected with the two accommodating cavities, respectively, and a bottom of the insulative housing includes two through holes that are interconnected with the two accommodating cavities, respectively, the insulative housing includes a first sidewall and a second sidewall that is perpendicular to the first sidewall, the first sidewall and the second sidewall have a corner area therebetween, and the corner area has a latching member; and
two conductive members disposed in the two accommodating cavities, respectively, and electrically connected with a conductive cable.

15. The wire end connector according to claim 14, wherein the insulative housing further includes a third sidewall that is parallel to the first sidewall, the second sidewall is located between the first sidewall and the third sidewall, and a width of the third sidewall is greater than a width of the first sidewall.

16. The wire end connector according to claim 14, wherein a step difference exists between the two lateral openings.

17. The wire end connector according to claim 14, wherein each of the conductive members includes a hollow cylindrical structure and a plate-shaped structure, the hollow cylindrical structure is located in a corresponding one of the accommodating cavities, and the plate-shaped structure is connected to the hollow cylindrical structure and extends toward a corresponding one of the lateral openings to be connected with the conductive cable.

18. The wire end connector according to claim 17, wherein an inner surface of the plate-shaped structure of each of the conductive members has a connection surface to be connected to the conductive cable.

19. The wire end connector according to claim 17, wherein the two conductive members further include two protruding ribs, respectively, each of the protruding ribs is disposed on an outer sidewall of the hollow cylindrical structure, the insulative housing has two recesses that respectively correspond to the two accommodation cavities, and the two protruding ribs are engaged into the two recesses, respectively.
